(19) United States
(12) Patent Application Publication
(10) Pub. No.: US 2004/0109480 A1
(43) Pub. Date: Jun. 10, 2004

(54) Atmosperic light beam projection apparatus and method

(76) Inventor: Dean VanDruff, Saratoga, CA (US)

Correspondence Address: Dean VanDruff, 14220 Pike Road, Saratoga, CA, 95070, US

(21) Appl. No.: 10/313,313

(22) Filed: Dec. 6, 2002

(51) Int. Cl. H01S 3/10

(52) U.S. Cl. 372/26

(57) ABSTRACT

The present invention is directed to an apparatus and method to create images on large and distant backdrops such as clouds.

### BACKGROUND OF THE INVENTION

1. Technical Field

The present invention is directed to an apparatus and method to create projected images on large or distant backdrops such as clouds.

2. Description of Related Art

Searchlights are used for grand-openings, sales, and other special events to gain public attention. But they cannot project detailed images.

Present laser vectoring systems (such as seen in planetariums and concerts) use one or more deflection mirrors which “wiggle” via controlled galvanometer to create an image, but are not suited for precise repetitive rastering. Very high-power lasers are difficult to use with this technique since the point of reflection is not rotating which creates a hot spot on the mirrored surface and a heat dissipation problem.

Present laser projection systems that can consistently raster projected images do so principally by rotating mirrored polygons, similar to the operation of UPC scanning systems used in supermarkets. While this works well for short-distance low throw-ratio projection, the problem with rotating polygons is that they create a fairly wide sweep, making long-distance high throw-ratio projection difficult to achieve by such means.

The present invention provides the means to project images over substantial distances and onto a variety of backdrops that have been heretofore unanticipated.

For example, rather than using searchlights, special events might be better served by putting informative or advertising information on the bottom of clouds on overcast nights. An example would be to project the word “SALE”, an arrow, a picture, or some other descriptive advertisement onto clouds, mountainsides, or a large man-made object.

With video-like projection capability, the apparatus of the present invention might also be useful for stadiums and other large events to replace traditional, expensive display screens.

### SUMMARY OF THE INVENTION

The present invention projects a modulated, rastered light beam onto the bottoms of clouds or any other distant backdrop.

### BRIEF DESCRIPTION OF THE DRAWINGS

The novel features believed characteristic of the invention are set forth in the appended claims. The invention itself, however, as well as an exemplary mode of use with further objectives and advantages thereof, will best be understood by reference to the following detailed description of an illustrative embodiment when read in conjunction with the accompanying drawing, wherein:

FIG. 1 is an exemplary illustration of an Atmospheric Light Beam Projection (ALBP) system in use.

FIG. 2 is an exemplary top view illustration of one embodiment of ALBP operation.

FIG. 3 is an exemplary side view illustration of one embodiment of ALBP operation.

FIG. 4 is a flowchart outlining an exemplary operation of the present invention.

### DETAILED DESCRIPTION OF THE PREFERRED EMBODIMENT

The present invention is an Atmospheric Light Beam Projection (ALBP) system method and apparatus.

“Light beam” herein refers to a laser, a composite of lasers, or any other directed light beam source such as a searchlight.

“Modulate” herein refers to the ability to turn the light beam on or off, or otherwise vary the intensity or the light source(s) in synchronization with the rastering to create a resultant image.

“Rasterize” herein refers to moving the light beam horizontally and vertically in a scanning motion, which in combination with the modulation creates the desired image.

“Throw ratio” herein refers to the projection distance to image width.

The unique aspect of the present invention is the conception and ability to use any fixed or slow moving object as a virtual screen for an image. The exemplary apparatus depicted shows one means by which to create the high projection throw-ratios required when the backdrop object is far away.

In the illustrative figures of the present invention, the throw ratios are shown as fairly low so as to make the dynamics of operation more plain.

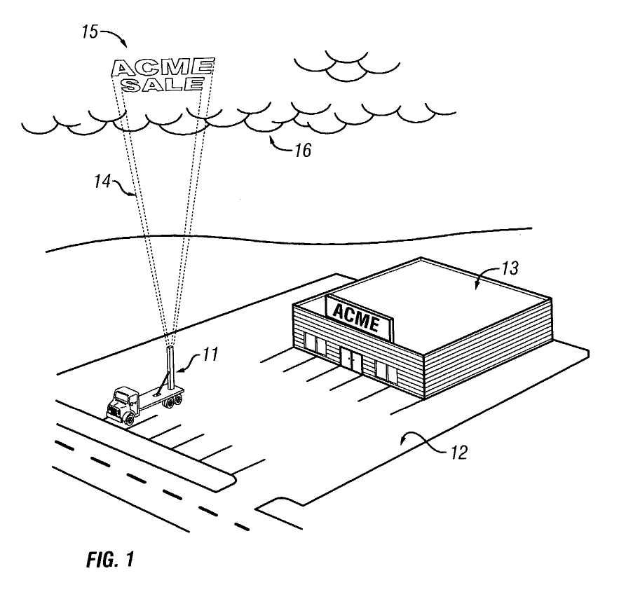

FIG. 1 is an exemplary illustration of an Atmospheric Light Beam Projection (ALBP) system in use. Shown for example is a truck mounted ALBP apparatus 11 in a parking lot 12 of a business 13 projecting 14 an advertising image 15 onto the bottom of clouds 16.

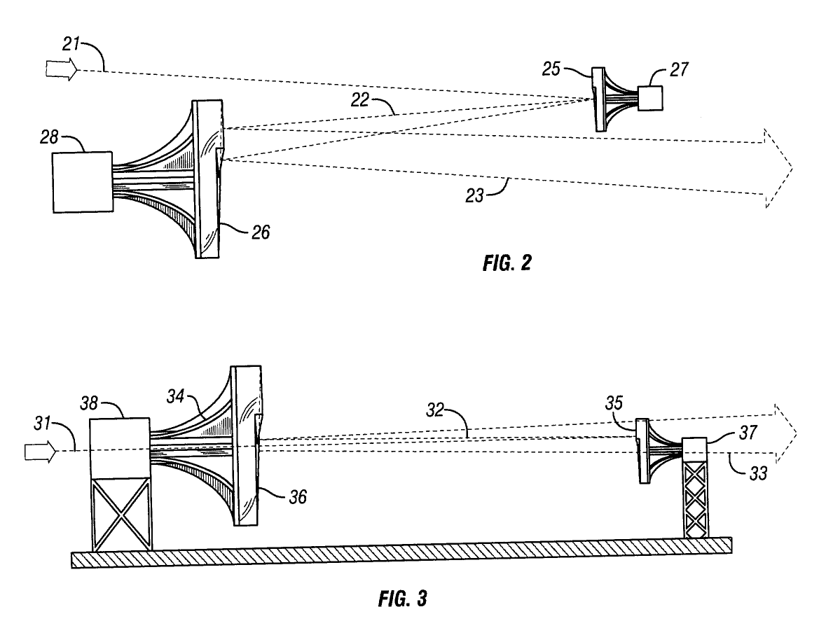

FIG. 2 is an exemplary top view illustration of one embodiment of ALBP operation. The motors 27,28 are precisely synchronized in coordination with the modulated light source. The horizontal motor 27 spins much faster than the vertical motor 28 to create each line in the raster. The modulated light beam 21 reflects off the linear varied angle surface of the Rotating Deflection Mirror (RDM) 25 for horizontal mastering. By striking the RDM 25 in the center from the top view, the reflected light beam is deflected from side to side 22 as the precision motor 27 rotates the mirrored surface. This deflected beam then strikes RDM 26 to the side from the top view, which as the RDM 26 precision motor 28 turns will deflect the light beam vertically for full composite rastering 23. While shown and described as being scanned horizontally first and vertically second, it should be plain that the reverse is also within the scope of the present invention.

FIG. 3 is an exemplary side view illustration of one embodiment of ALBP operation. The modulated light beam 31 strikes the RDM 35 in the upper section from the side view, such that the reflected light beam is deflected from side to side 32 as the precision motor 37 rotates the mirrored surface. This deflected beam then strikes RDM 36 in the center from the side view, which as the RDM 36 precision motor 38 turns will deflect the light beam vertically for full composite rastering 33. Rotating deflection mirrors 35,36 may have fins 34 that serve the function of fan blades to help dissipate heat.

The exemplary apparatus embodiment uses linear variations in the surfaces of rotating mirrors to achieve rastering, which has the advantage of being able to achieve very high throw ratios.

The light beam may be a single laser or searchlight that projects a black and white (or black and laser color) image, or a composite laser for color projection.

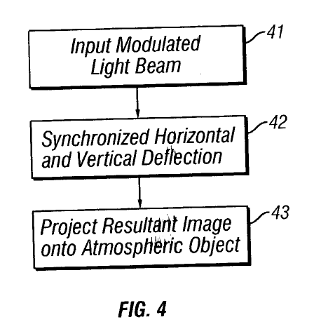

FIG. 4 is a flowchart outlining an exemplary operation of the present invention. A modulated light beam 41 is deflected horizontally and vertically 42 and then projected onto a distant atmospheric object 43.

Rasteration through polygonal mirror rotation and/or controlled deflection of mirrors by precision galvanometer controls may also be used for ALBP operation. Such is not depicted in drawings herein as this means of operation is well known in the art. Any use of such for projection on clouds or other atmospheric applications, however, is claimed to be within the scope of this present invention.

Another possible use of the present invention is for projection onto mountainsides, distant cloud formations from the side, or other non-planar natural surfaces. Lasers can be designed not to spread out substantially over distance. Given this, if ALBP is implemented with high-power lasers than there is near infinite depth of field. This means that nearly any backdrop used as a “screen” will still yield a reasonably good image if the viewer is substantially in-line with the projection.

Another possible use of ALBP is to project images onto buildings or other large, man-made structures or objects such as blimps or balloons. The high throw ratio of the exemplary apparatus depicted would also function well in large stadiums for projection across the stadium to a screen surface on the other side.

Yet another possible and unusual potential use of the present invention is to project a very high power laser image onto the surface of a new moon.

One benefit of patenting this new and unique projection method and apparatus is to assist in legally limiting its use to socially acceptable venues.

While the exemplary means to rasterize the light beam is shown for the purpose of atmospheric scale projection, it should be clear to those in the art that the rasterization method and apparatus depicted can also be used for low-power, small-scale, and small throw-ratio applications. The present invention claims both the method of atmospheric projection in general, and this embodiment of rasterization technique in particular in any projection application.

While the present invention is described and shown in the preferred embodiments depicted, it should be apparent by those skilled in the art that other embodiments not shown would be within the spirit and scope of this invention. The description of the present invention is not exhaustive nor is the invention limited to the forms disclosed. The embodiment was chosen and described in order to explain the principles of the invention, the practical application, and to enable others of ordinary skill in the art to understand the invention for various embodiments with various modifications as are suited to the particular use contemplated.

What is claimed is:

1. A method for projecting a light beam onto clouds comprising:
a modulation of the beam;
a means by which to rasterize the beam; and
a coordination of the modulation and rasterization to create the projected image.

2. The method of claim 1, wherein the light beam is a laser or composite of lasers.

3. The method of claim 1, wherein the light beam is a searchlight.

4. The method of claim 1, wherein the means of light beam modulation is of any sort.

5. The method of claim 1, wherein the means by which the light beam is rasterized is of any sort.

6. The method of claim 1, wherein the image is projected onto a mountainside or other natural backdrop.

7. The method of claim 1, wherein the image is projected onto the side of a building, a blimp or balloon, or any other man-made object or screen as a backdrop with a throw ratio of greater than 30:1.

8. The method of claim 1, wherein the image is projected onto the moon.

9. The apparatus for projecting a light beam onto clouds comprising:
a modulation of the beam;
a means by which to rasterize the beam; and
a coordination of the modulation and rasterization to create the projected image.

10. The apparatus of claim 9, wherein the light beam is a laser or composite of lasers.

11. The apparatus of claim 9, wherein the light beam is a searchlight.

12. The apparatus of claim 9, wherein the light beam is rasterized through rotating variable pitched mirrors.

13. The apparatus of claim 9, wherein the light beam is rasterized through rotating polygonal mirrors.

14. The apparatus of claim 9, wherein the means by which the light beam is rasterized is through precision galvanometer controlled mirrors.

15. The apparatus of claim 9, wherein the means of light beam modulation is a combination of rotating variable pitched mirrors, rotating polygonal mirrors, and precision galvanometer controlled mirrors.

16. The apparatus of claim 9, wherein the means by which the light beam is rasterized is of any sort.

19. The apparatus of claim 9, wherein the image is projected onto a mountainside or other natural backdrop.

18. The apparatus of claim 9, wherein the image is projected onto the side of a building, a blimp or balloon, or any other man-made object or screen as a backdrop with a throw ratio of greater than 30:1.

19. The apparatus of claim 9, wherein the image is projected onto the moon.

20. The apparatus of claim 9, wherein a rotating variable pitched mirror is used as shown for any light beam projection application.
